(19) United States
(12) Patent Application Publication
(10) Pub. No.: US 2011/0056767 A1
(43) Pub. Date: Mar. 10, 2011

(54) Ladder Tool Box The "LTB"

(76) Inventors: Anthony Michael Maglieri, Camarillo, CA (US); Eddie Dean Eaton, Joliet, IL (US)

(21) Appl. No.: 12/717,120

(22) Filed: Mar. 3, 2010

Related U.S. Application Data
(63) Continuation-in-part of application No. 12/546,569, filed on Sep. 10, 2009.

(51) Int. Cl. E06C 7/00; E06C 7/14

(52) U.S. Cl. 182/129

(57) ABSTRACT

The ladder tool box is a plastic toolbox designed to attach to the top rung of an “A” frame type ladder. It has three drop down drawers for tool and misc. screw storage. The ladder tool box rests on the top rung of any “A” frame type ladder and secures to the sides of the ladder frame. The ladder tool box is designed to stop the use of the warning rung on the ladder as well as to utilize the space for tool and misc. screw storage.

The description is a continuation in part of application Ser. No. 12/546,569 filed Sep. 10, 2009

The ladder tool box is designed to attach to the top rung of an “A” frame type ladder. The placement of the ladder tool box is to stop a worker from stepping on the warning rung as well as to utilize the ladder top rung space for tool storage. The ladder tool box “LTB” can be made of plastic, fiberglass, stainless steel, wood, aluminum or cloth or canvas materials. The Ladder tool box “LTB” main function is to assist in tool management and storage systems and attach on any “A” Frame type ladder in the space between the ladder top cap and the warning rung.

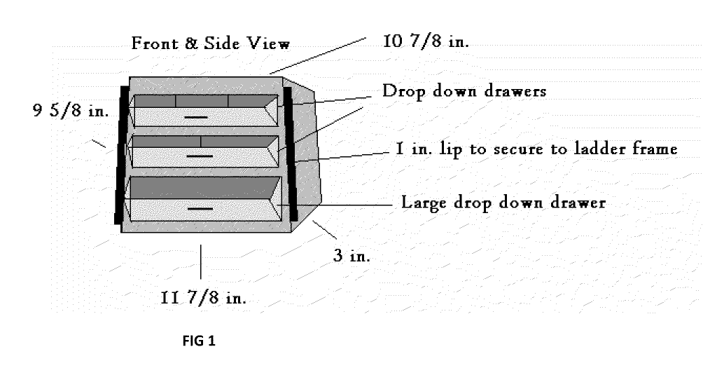

FIG. 1 displays the front and side view with 3 drop down drawers for tools and misc. screw storage. The ladder tool box attaches to the top rung of any “A” frame type ladder and secures to the ladder frame.

The ladder tool box is made of heavy duty plastic and is removable. The dimensions are 10.⅞ inches in length, 9.⅝ inches in height and 3 inches in width.

1. The ladder tool box is designed to attach to the top rung of an “A” frame type ladder. The placement of the ladder tool box is to stop a worker from stepping on the warning rung as well as to utilize the ladder top rung space for tool storage.
